(19) United States
(12) Patent Application Publication
(10) Pub. No.: US 2017/0294262 A1
(43) Pub. Date: Oct. 12, 2017

(54) METHOD OF MANUFACTURING INDUCTOR AND INDUCTOR

(71) Applicant: SAMSUNG ELECTRO-MECHANICS CO., LTD., Suwon-si (KR)

(72) Inventors: Jong Yun LEE, Suwon-si (KR); Hye Won BANG, Suwon-si (KR); Jin Hyuck YANG, Suwon-si (KR); Young Seuck YOO, Suwon-si (KR)

(21) Appl. No.: 15/474,710

(22) Filed: Mar. 30, 2017

(30) Foreign Application Priority Data
Apr. 11, 2016 (KR) 10-2016-0044334

(51) Int. Cl. H01F 27/28; H01F 27/29; H01F 41/04

(52) U.S. Cl. CPC H01F 27/2804; H01F 41/041; H01F 27/29

(57) ABSTRACT

A method of manufacturing an inductor includes forming a step portion having a high-resolution pattern by using a photosensitive layer with photosensitive characteristics, and forming a low-resistance coil pattern by filling the step portion with a metal paste having a lower resistance than a photosensitive metal paste.

### CROSS-REFERENCE TO RELATED APPLICATION

This application claims the benefit of priority to Korean Patent Application No. 10-2016-0044334, filed on Apr. 11, 2016 with the Korean Intellectual Property Office, the entirety of which is incorporated herein by reference.

### BACKGROUND

### 1. Field

The present disclosure relates to a method of manufacturing a surface-mount device (SMD) inductor, particularly, an inductor used in a high frequency band of 100 MHz or more.

### 2. Description of Related Art

An inductor is a surface-mount device (SMD) component mounted on a circuit board.

Such a product, used at a high frequency of 100 MHz or more, is commonly referred to as a high-frequency inductor.

A high-frequency inductor is mainly used in an LC circuit for impedance matching. As various frequencies are used in accordance with the recent trend for multi-band devices in the wireless communications market, the number of matching circuits have significantly increased, which has also increased the use of high-frequency inductors.

The most important technical trend in high-frequency inductors is the implementation of a high-Q factor. Here, Q may be wL/R (Q=wL/R). That is, a Q value is a ratio of inductance (L) and resistance (R) in a given frequency band. Due to the trend for miniaturization of electronic components, it is important to increase the Q value while decreasing the size of the element.

Since a high-frequency inductor is used in an impedance matching circuit, it may be manufactured to be suitable for a specific nominal inductance (L).

In order to implement a high-Q factor, the inductor must be manufactured to have a higher Q value at a constant nominal inductance L.

In order to obtain a small, thin product while maintaining a higher Q value, there is a need for miniaturization of inductor coils and precise matching of the inductor coils.

At present, a photosensitive metal paste is used in a process of manufacturing a high-frequency inductor.

The use of the photosensitive metal paste is advantageous in precisely matching inductor coils and constantly maintaining the shape of a high-frequency inductor after the manufacturing of the high-frequency inductor. However, this requires photosensitive characteristics to be given to the metal paste. This causes the metal paste to have a greater resistance than that of a common metal paste, thus affecting the Q value and limiting the ability to improve the characteristics of the high-frequency inductor.

Further, the photosensitive characteristics given to the metal paste are lower than the unique photosensitive characteristics of a common photosensitive layer, whereby resolution obtained by using the metal paste may be less than what can be obtained using a common photosensitive layer.

In multilayer ceramic technology according to the related art described above, it is difficult to increase a thickness of a conducting wire and remove a step portion.

### SUMMARY

According to an aspect of the present disclosure, a method of manufacturing an inductor includes: coating a passivation layer on a support member; laminating a dry film resist on the passivation layer; forming a dry film pattern by exposing and developing the dry film resist; forming a coil pattern by printing a metal paste on the dry film pattern; removing the dry film resist; coating the passivation layer on the coil pattern; and forming a via in the passivation layer.

According to another aspect of the present disclosure, an inductor includes: a body having a coil part; and an external electrode disposed on an external surface of the body, and connected to the coil part. The coil part has a conductive pattern and a conductive via. The conductive pattern and the conductive via are formed of metal pastes having resistance lower than resistance of a photosensitive metal paste.

### BRIEF DESCRIPTION OF DRAWINGS

The above and other aspects, features, and advantages of the present disclosure will be more clearly understood from the following detailed description, taken in conjunction with the accompanying drawings, in which:

FIGS. 1A through 1S are views of a process of manufacturing an inductor, according to an embodiment;

FIG. 2 is a cross-sectional view of a body formed by repeating operations of FIGS. 1A through 1S; and

FIG. 3 is a cross-sectional view of an inductor in which external electrodes are formed on the body of FIG. 2.

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on,” “above,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no other elements or layers intervening therebetween. Like numerals refer to like elements throughout.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Spatially relative terms, such as “above,” “upper,” “below,” and “lower” and the like, may be used herein for ease of description to describe one element's relationship relative to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” relative to other elements would then be oriented “below,” or “lower” relative to the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein describes particular embodiments only, and the present disclosure is not limited thereby.

Hereinafter, embodiments of the present disclosure will be described with reference to schematic views illustrating embodiments of the present disclosure. In the drawings, for example, due to manufacturing techniques and/or tolerances, modifications of the shape shown may be estimated. Thus, embodiments of the present disclosure should not be construed as being limited to the particular shapes of regions shown herein, for example, to include a change in shape results in manufacturing. The following embodiments may also be constituted by one or a combination thereof.

The contents of the present disclosure described below may have a variety of configurations and only a required configuration is proposed herein, but the present disclosure is not limited thereto.

### Method of Manufacturing Inductor

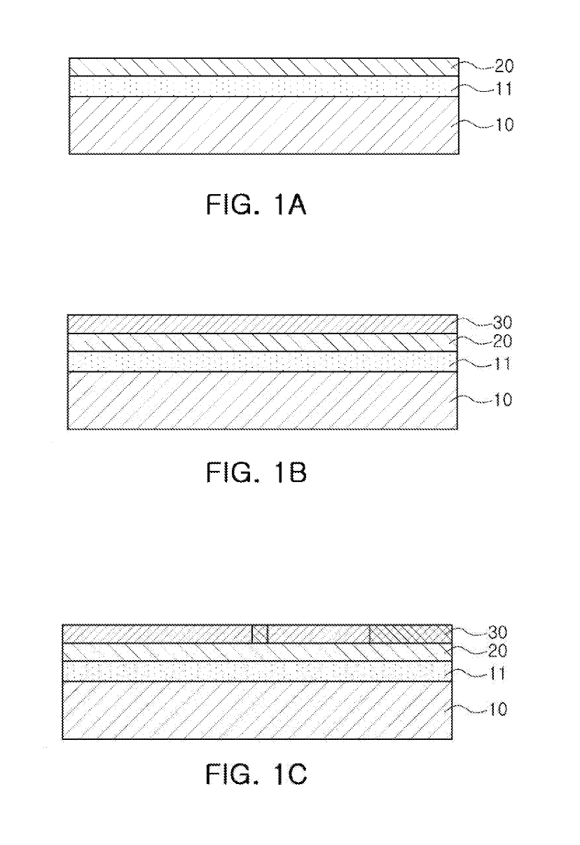

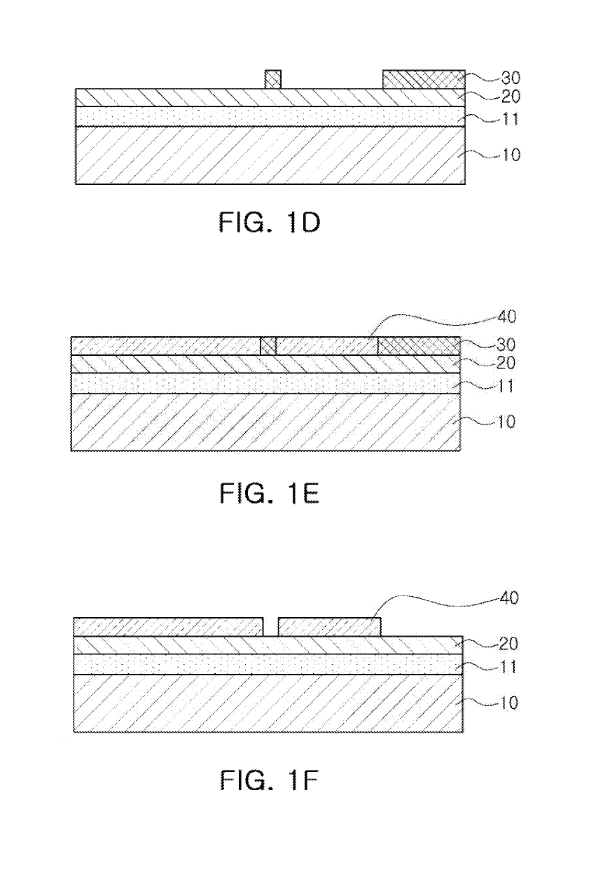

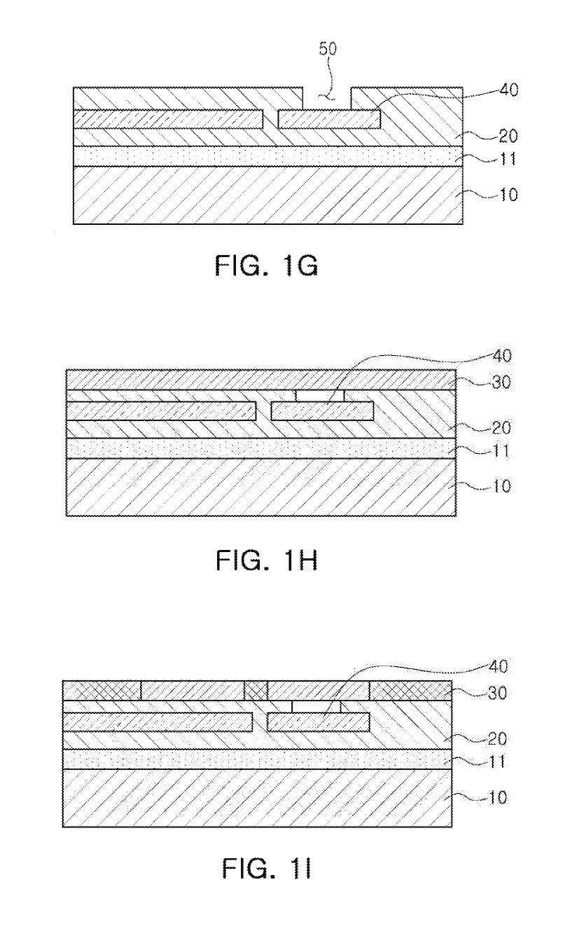

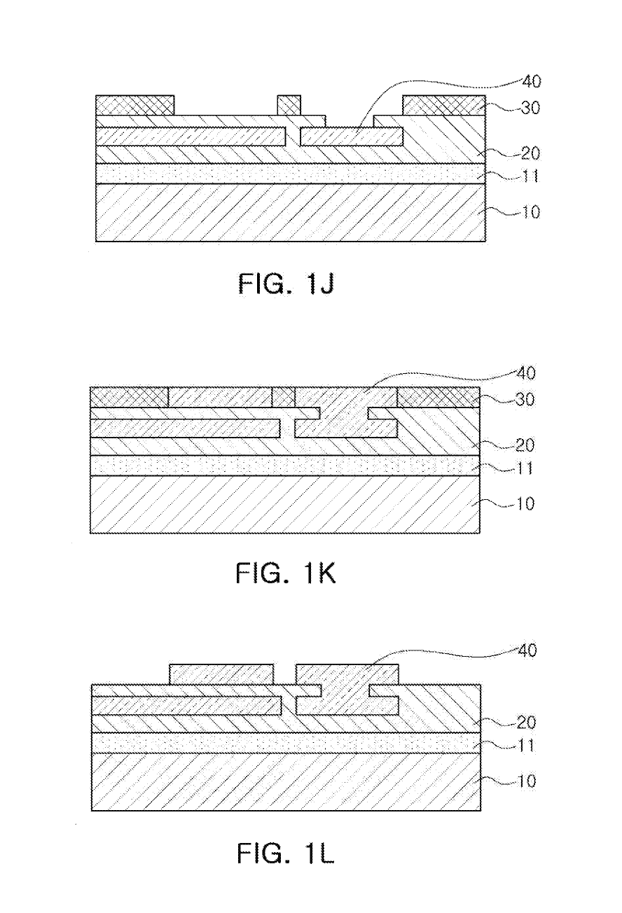

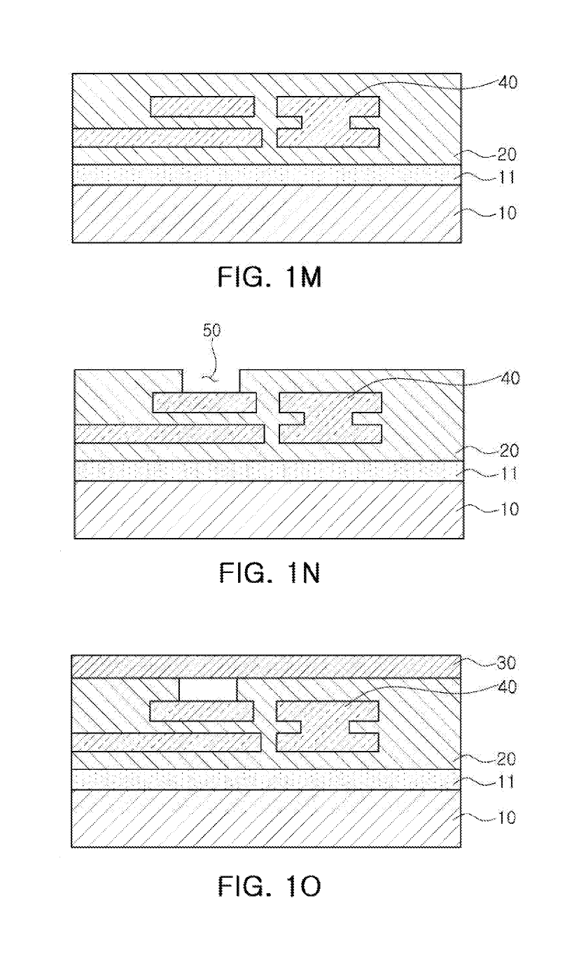

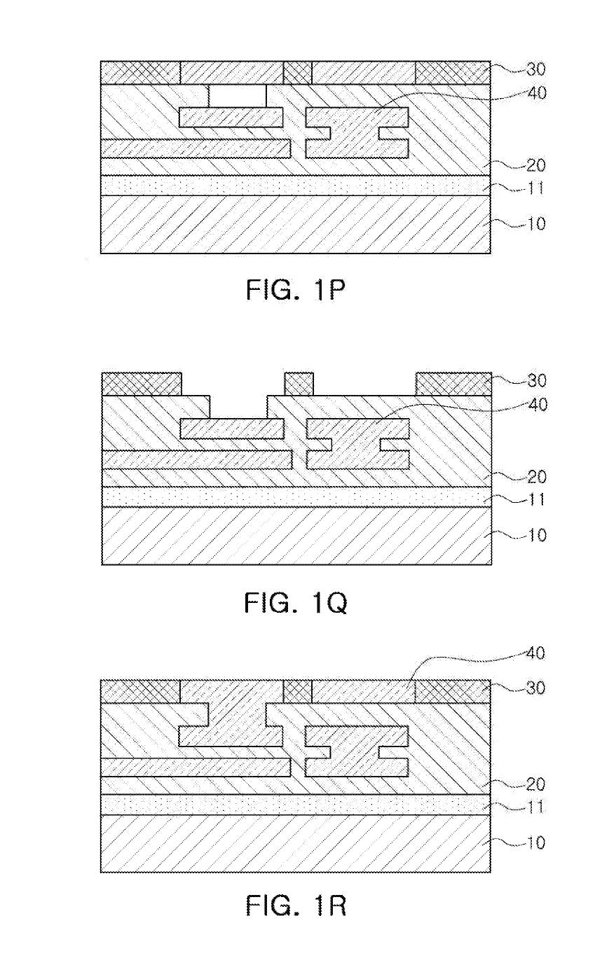

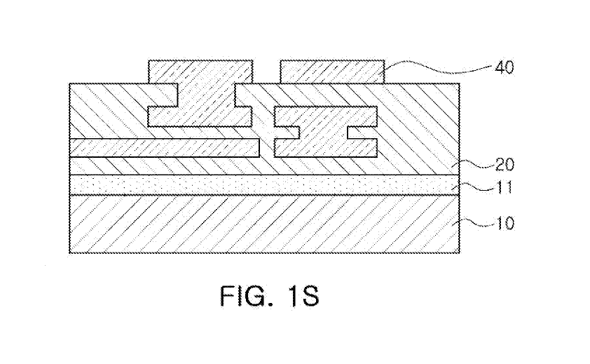

FIGS. 1A through 1S are views of a process of manufacturing an inductor, according to an embodiment.

According to an embodiment, there may be provided a method of manufacturing an inductor, the method including: coating a passivation layer on a support member; laminating a dry film resist on the passivation layer; forming a dry film pattern by exposing and developing the dry film resist; forming a coil pattern by printing a metal paste on the dry film pattern; removing the dry film resist; coating the passivation layer on the coil pattern; and forming a via in the passivation layer.

Hereinafter, the respective operations are described in detail.

FIG. 1A illustrates a passivation layer coated on a support member. Referring to FIG. 1A, a support member includes a substrate 10 and an adhesive 11 bonded to the substrate 10, and the adhesive 11 may be a foam tape.

The substrate 10 is not particularly limited, and any member having rigidity that may support any other component may be used as the substrate 10 without limitation.

The passivation layer 20 is coated on the support member.

FIG. 1B illustrates a dry film resist laminated on the passivation layer. Referring to FIG. 1B, the dry film resist 30 is laminated on the passivation layer 20 to form a circuit pattern. The dry film resist 30 is a subsidiary material for exposure/development.

FIGS. 1C and 1D illustrate the formation of a dry film pattern by exposure and development of the dry film resist. Referring to FIG. 1C, an exposure/development process is conducted for dry film resist 30 to form the dry film pattern 30 shown in FIG. 1D.

FIG. 1E illustrates a coil pattern formed by printing metal paste on the dry film pattern. Referring to FIG. 1E, a coil pattern 40 is formed by printing a metal paste on the dry film pattern 30.

The metal paste contains a metal with a lower resistance than that of a photosensitive metal paste.

Photosensitive metal pastes are generally used when manufacturing high-frequency inductors.

The use of the photosensitive metal paste is advantageous to precisely match inductor coils and constantly maintain the shape of a high-frequency inductor after the manufacturing of the high-frequency inductor. However, photosensitive characteristics need to be provided to the metal paste, which may cause the metal paste to have a greater resistance than a common metal paste. The greater resistance of the photosensitive metal paste may negatively affect the Q value of the high-frequency inductor, which decreases as resistance increases, and thus limit the ability to improve the characteristics of the high-frequency inductor.

Further, the photosensitive characteristics provided to the metal paste are lower than those of a common photosensitive layer. As such, the resolution obtained when using a photosensitive metal paste is less than that obtained when using a common photosensitive layer.

In contrast, according to the present disclosure, the coil pattern 40 can be formed by printing a metal paste with a lower resistance than a photosensitive metal paste. This permits coil pattern to be formed with a lower resistance and a finer coil pattern resolution.

Furthermore, the inductor can have an excellent Q factor due to the low resistance of the coil pattern 40.

FIG. 1F illustrates the dry film pattern removed. Referring to FIG. 1F, the coil pattern 40 is completed by removing the dry film pattern 30.

FIG. 1G illustrates another passivation layer coated on the coil pattern. Referring to FIG. 1G, another passivation layer is coated to form the passivation layer 20 on the coil pattern 40.

The passivation layer 20 includes the passivation layer coated on the support member in FIG. 1A. That is, the passivation layer 20 of FIG. 1G includes the portion coated on the coil pattern 40 as well as the portion coated on the support member as described above in relation to FIG. 1A.

FIG. 1G illustrates a via hole formed in the passivation layer Referring to FIG. 1G, a via hole 50 is formed in the passivation layer 20.

The formation of the via hole can be performed by hiding a portion of the passivation layer 20 where the via is to be formed, using a mask, and by exposing and developing the portion.

FIG. 1H illustrates another dry film resist laminated on the passivation layer. Referring to FIG. 1H, another dry film resist 30 is laminated on the passivation layer 20 for forming an upper circuit pattern. The dry film resist 30 is a subsidiary material for exposure/development.

FIGS. 1I and 1J illustrate the formation of a dry film pattern by exposure and development of the dry film resist. Referring to FIG. 1I, an exposure/development process is conducted for dry film resist 30 to form the dry film pattern 30 shown in FIG. 1J.

FIG. 1K illustrates a coil pattern formed by printing metal paste on the dry film pattern. Referring to FIG. 1K, a coil pattern 40 is formed by printing a metal paste on the dry film pattern. The metal paste is formed in the via hole 50 to form a via portion of the coil pattern. The coil pattern 40 includes the portion of the coil pattern formed in FIG. 1F.

FIG. 1L illustrates the dry film pattern removed. Referring to FIG. 1L, the coil pattern 40 is completed by removing the dry film pattern 30.

FIG. 1M illustrates yet another passivation layer coated on the coil pattern. Referring to FIG. 1M, another passivation layer is coated to form passivation layer 20 on the coil pattern 40.

The passivation layer 20 includes the previous passivation layers. That is, the passivation layer 20 of FIG. 1M includes the portions coated in FIGS. 1A and 1G.

FIG. 1N illustrates Referring to FIG. 1N, a via hole 50 is formed in the passivation layer 20.

The formation of the via hole is performed by hiding a portion of the passivation layer 20 where the via is to be formed, using a mask, and by exposing and developing the portion.

FIG. 1O illustrates another dry film resist formed on the passivation layer. Referring to FIG. 1O, a dry film resist 30 is laminated on the passivation layer 20 for forming an upper circuit pattern.

FIGS. 1P and 1Q illustrate the formation of the dry film pattern by exposure and development of the dry film resist. Referring to FIG. 1P, an exposure/development process is conducted for dry film resist 30 to form the dry film pattern 30 shown in FIG. 1Q.

FIG. 1R illustrates a coil pattern formed by printing metal paste on the dry film pattern. Referring to FIG. 1R, a coil pattern 40 is formed by printing a metal paste on the dry film pattern. The metal paste is formed in the via hole 50 to form a via portion of the coil pattern. The coil pattern 40 includes the portions of the coil pattern formed in FIGS. 1F and 1K.

FIG. 1S illustrates the dry film pattern removed. Referring to FIG. 1S, the coil pattern 40 is completed by removing the DFR 30.

By repeating the above-mentioned operations, coil patterns formed on dry film patterns are laminated to be connected to each other by vias, thus forming a laminate. The laminate is completed by coating a passivation layer on an uppermost coil pattern of coil pattern 40.

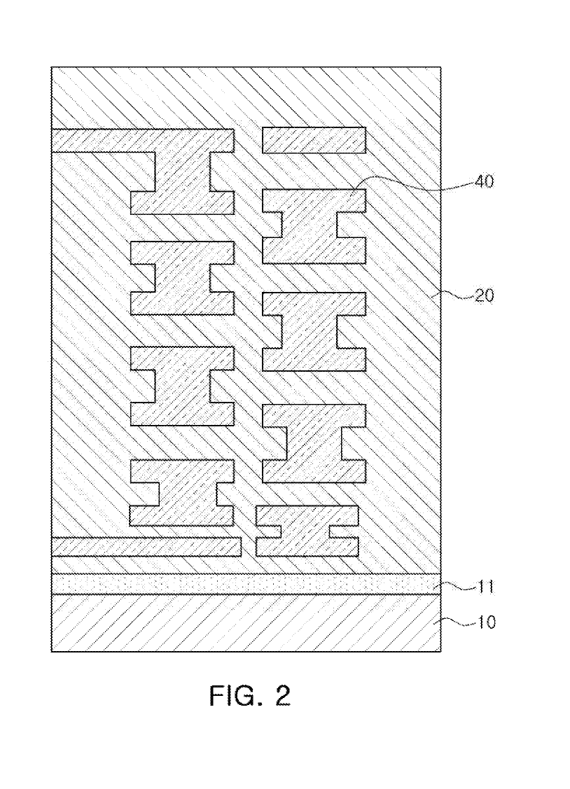

FIG. 2 is a cross-sectional view of a body formed by repeating the operations of FIGS. 1A through 1S.

Referring to FIG. 2, the body is formed by cutting and sintering the laminate after the coating of the passivation layer 20 on the coil pattern 40.

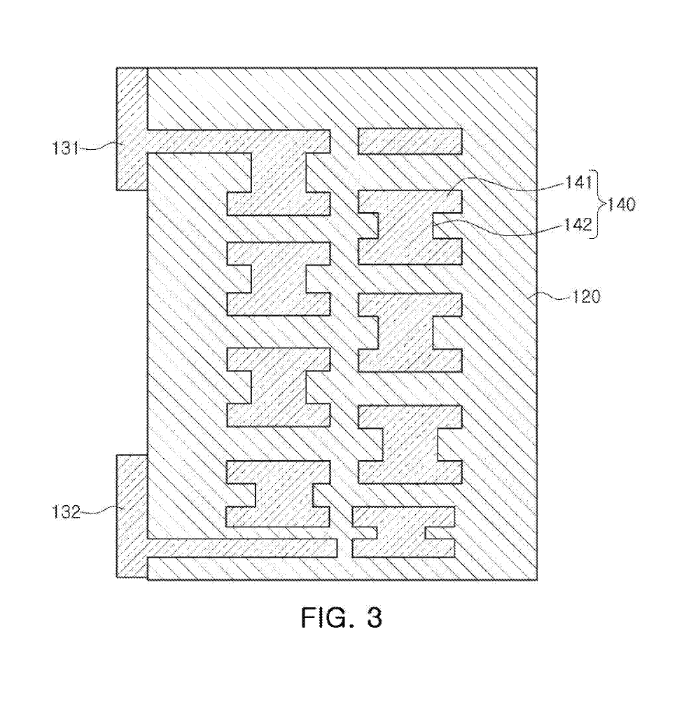

FIG. 3 is a cross-sectional view of an inductor in which external electrodes are formed on the body of FIG. 2.

Referring to FIG. 3, a support member is removed from the laminate, and external electrodes 131 and 132 are formed on an external surface of a body 120. Thus, an inductor including a coil part 140 disposed inside the body 120 and the external electrodes 131 and 132 disposed on the external surface of the body 120 may be manufactured.

### Inductor

An inductor according to another embodiment includes the body 120 including the coil part 140, and external electrodes 131 and 132 disposed on an external surface of the body 120.

The coil part 140 includes a conductive pattern 141 and a conductive via 142.

The conductive pattern 141 and the conductive via 142 may be formed of metal pastes with lower resistance than a photosensitive metal paste.

The body 120 of the inductor may be formed of a ceramic material such as glass ceramic, Al₂O₃, or ferrite, but is not limited thereto, and may also contain an organic component.

The conductive pattern 141 and the conductive via 142 may be formed of silver (Ag), but is not limited thereto.

Meanwhile, the coil part 140 may be disposed to be perpendicular to a mounting surface of the inductor, but is not limited thereto.

As set forth above, according to an embodiment, there may be provided a method of manufacturing an inductor, the method including: forming a step portion having a high-resolution pattern using a photosensitive layer with photosensitive characteristics; and forming a low-resistance coil pattern by filling the step portion with a metal paste having lower resistance than that of a photosensitive metal paste.

According to an embodiment, an inductor with an excellent Q factor may be implemented due to the low resistance of the coil pattern.

While exemplary embodiments have been shown and described above, it will be apparent to those skilled in the art that modifications and variations could be made without departing from the scope of the present invention as defined by the appended claims.

What is claimed is:

1. A method of manufacturing an inductor comprising:
coating a passivation layer on a support member;
laminating a dry film resist layer on the passivation layer;
forming a dry film pattern by exposing and developing the dry film resist layer;
forming a coil pattern by printing a metal paste on the dry film pattern;
removing the dry film resist layer;
coating another passivation layer on the coil pattern; and
forming a via hole in the passivation layer.

2. The method of claim 1, further comprising, after the forming the via hole, forming a laminate by repeated operations of:
laminating another dry film resist layer on the passivation layer;
forming a dry film pattern by exposing and developing the dry film resist layer;
forming another coil pattern by printing a metal paste on the dry film pattern;
removing the dry film resist layer; and
coating another passivation layer on the coil pattern.

3. The method of claim 2, further comprising, cutting and sintering the laminate after coating the passivation layer on the coil pattern.

4. The method of claim 3, further comprising:
removing the support member from the laminate; and
forming an external electrode on an external surface of the laminate.

5. The method of claim 1, wherein the metal paste has a resistance lower than a resistance of a photosensitive metal paste.

6. The method of claim 1, wherein forming the via hole is performed by exposing and developing the passivation layer.

7. The method of claim 1, wherein the coil pattern formed on the dry film pattern is provided as a plurality of coil patterns, and the coil patterns are connected to each other by a via formed in the via hole.

8. An inductor comprising:
a body including a coil part; and
an external electrode disposed on an external surface of the body, and connected to the coil part,
wherein the coil part has a conductive pattern and a conductive via, and the conductive pattern and the conductive via each have a resistance lower than a resistance of a conductive pattern formed from a photosensitive metal paste.

9. The inductor of claim 8, wherein the conductive pattern and the conductive via contain silver (Ag).
